(19) United States
(12) Patent Application Publication
(10) Pub. No.: US 2005/0033521 A1
(43) Pub. Date: Feb. 10, 2005

(54) Method for predicting responses to PDE4 inhibitors using biomarkers

(76) Inventors: Seth Gary Michelson, San Jose, CA (US); Christina Maria Friedrich, San Francisco, CA (US); Leif Gustaf Wennerberg, Mountain View, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/640,470

(22) Filed: Aug. 12, 2003

Related U.S. Application Data
(63) Continuation-in-part of application No. 10/319,779, filed on Dec. 12, 2002.

(51) Int. Cl. G06F 19/00

(52) U.S. Cl. 702/19

(57) ABSTRACT

Methods for predicting effectiveness of a PDE4 inhibitor are described. In one embodiment, a method includes administering a β₂-agonist to a patient having asthma and applying a measurement to the patient to determine a treated result of the measurement. The measurement is configured to evaluate effectiveness of the β₂-agonist for the patient. The method also includes predicting effectiveness of the PDE4 inhibitor for the patient based on the treated result of the measurement.

### CROSS REFERENCE TO RELATED APPLICATION

This application is a continuation-in-part of U.S. patent application Ser. No. 10/319,779, entitled “Apparatus and Method for Identifying Biomarkers Using a Computer Model” and filed on Dec. 12, 2002, the disclosure of which is incorporated herein by reference in its entirety.

### COPYRIGHT NOTICE

A portion of the disclosure of the patent document contains material that is subject to copyright protection. The copyright owner has no objection to the facsimile reproduction by anyone of the patent document, as it appears in the Patent and Trademark Office patent file or records, but otherwise reserves all copyright rights whatsoever.

### FIELD OF THE INVENTION

The field of the invention relates to phosphodiesterase 4 (“PDE4”) inhibitors. For example, methods for predicting effectiveness of PDE4 inhibitors using biomarkers are described.

### BACKGROUND OF THE INVENTION

Respiratory diseases are a widespread problem in the United States and the rest of the world. A common respiratory disease is asthma. Asthma is typically associated with inflammation and obstruction of the respiratory tract and is characterized by a number of symptoms, such as, for example, wheezing, cough, shortness of breath, and dyspnea. Despite many recent advances, asthma remains a poorly understood and often poorly treated respiratory disease. If left untreated, asthma can lead to mucosal damage and other structural changes that can sometimes give rise to irreversible airway narrowing and fibrosis of lung tissue.

An important class of therapies that can be used to treat asthma includes PDE4 inhibitors. The development of a new PDE4 inhibitor is a costly and time-consuming process, and it would be desirable to use one or more biomarkers associated with the PDE4 inhibitor to facilitate this process. For example, a biomarker that is predictive of effectiveness of the PDE4 inhibitor could be used as an inclusion or exclusion criteria, such that a clinical trial can target human patients that are likely to respond well to the PDE4 inhibitor. Also, subsequent to the development of the PDE4 inhibitor, it would be desirable to use one or more biomarkers in connection with treating human patients suffering from asthma. For example, a biomarker that is predictive of effectiveness of the PDE4 inhibitor could be used by physicians to identify human patients that are likely to respond well to the PDE4 inhibitor.

It is against this background that a need arose to develop the methods described herein.

### SUMMARY OF THE INVENTION

In one innovative aspect, the invention relates to a method of predicting effectiveness of a PDE4 inhibitor. In one embodiment, the method includes administering a β₂-agonist to a patient having asthma and applying a measurement to the patient to determine a treated result of the measurement. The measurement is configured to evaluate effectiveness of the β₂-agonist for the patient. The method also includes predicting effectiveness of the PDE4 inhibitor for the patient based on the treated result of the measurement.

In another embodiment, the method includes administering a CysLT inhibitor to a patient having asthma and applying a measurement to the patient to determine a treated result of the measurement. The measurement is configured to evaluate effectiveness of the CysLT inhibitor for the patient. The method also includes predicting effectiveness of the PDE4 inhibitor for the patient based on the treated result of the measurement.

In another innovative aspect, the invention relates to a method of performing a clinical trial of a PDE4 inhibitor. In one embodiment, the method includes administering a therapy to a human patient. The therapy includes at least one of a β₂-agonist and a CysLT inhibitor. The method also includes applying a measurement to the human patient to determine a response of the human patient to the therapy. The method further includes selecting the human patient for the clinical trial of the PDE4 inhibitor based on the response of the human patient to the therapy.

### BRIEF DESCRIPTION OF THE DRAWINGS

For a better understanding of the nature and objects of some embodiments of the invention, reference should be made to the following detailed description taken in conjunction with the accompanying drawings, in which:

FIG. 1 illustrates a system block diagram of a computer system that can be operated in accordance with some embodiments of the invention.

FIG. 2 illustrates a spider chart for various virtual patients that can be defined to represent different human patients, according to an embodiment of the invention.

FIG. 3 illustrates a bar chart for various virtual patients that can be defined to represent different human patients, according to an embodiment of the invention.

FIG. 4 illustrates a scatter-gram that plots outputs of two virtual therapies for various virtual patients, according to an embodiment of the invention.

FIG. 5 illustrates another scatter-gram that plots outputs of two virtual therapies for various virtual patients, according to an embodiment of the invention.

FIG. 6 illustrates a further scatter-gram that plots outputs for various virtual patients, according to an embodiment of the invention.

FIG. 7 illustrates a flow chart for predicting a response of a patient to a PDE4 inhibitor, according to an embodiment of the invention.

### DETAILED DESCRIPTION OF SPECIFIC EMBODIMENTS

### Overview

Embodiments of the invention relate to PDE4 inhibitors. For example, methods for predicting effectiveness of PDE4 inhibitors using biomarkers are described. According to some embodiments of the invention, a response of a patient to either, or both, of a β₂-agonist and a cysteinyl leukotriene (“CysLT”) inhibitor can serve as a biomarker that is predictive of effectiveness of a PDE4 inhibitor.

Advantageously, use of the methods described herein can play a key role in developing PDE4 inhibitors to treat various diseases, such as, for example, mild or moderate asthma. For example, a biomarker of a PDE4 inhibitor can be evaluated for a human patient to predict the degree of effectiveness of the PDE4 inhibitor for that human patient prior to a clinical trial. Such a biomarker can be used as an inclusion or exclusion criteria to select a group of human patients for the clinical trial, such that the clinical trial can target human patients that are likely to respond well to the PDE4 inhibitor. As another example, a biomarker of the PDE4 inhibitor can be evaluated for a group of human patients as a variance reducing measure in the design of the clinical trial. Such a biomarker can be evaluated as a continuous value and can be used as a covariate in an analysis of covariance for the clinical trial.

Subsequent to developing PDE4 inhibitors, use of the methods described herein can also play a key role in implementing the PDE4 inhibitors to treat various diseases. For example, a biomarker of a PDE4 inhibitor can be evaluated for a human patient to predict the degree of effectiveness of the PDE4 inhibitor for that human patient. Such a biomarker can be used by physicians to select human patients that are likely to respond well to the PDE4 inhibitor.

### Definitions

The following definitions apply to some of the elements described with regard to some embodiments of the invention. These definitions may likewise be expanded upon herein.

The term “set” refers to a collection of one or more elements. Elements of a set can also be referred to as members of the set. Elements of a set can be the same or different. In some instances, elements of a set can share one or more common characteristics.

The term “patient” refers to a biological system to which a therapy can be administered. A biological system can include, for example, an individual cell, a set of cells (e.g., a cell culture), an organ, a tissue, or a multi-cellular organism. A patient can refer to a human patient or a non-human patient. In some instances, a patient can have a respiratory disease, such as, for example, mild or moderate asthma. Patients having a respiratory disease can include, for example, patients that have been diagnosed with the respiratory disease, patients that exhibit a set of symptoms associated with the respiratory disease, or patients that are progressing towards or are at risk of developing the respiratory disease.

The term “biological constituent” refers to a portion of a biological system. A biological constituent that makes up a biological system can include, for example, an extra-cellular constituent, a cellular constituent, an intra-cellular constituent, or a combination thereof. Examples of biological constituents include DNA; RNA; proteins; enzymes; hormones; cells; organs; tissues; portions of cells, tissues, or organs; subcellular organelles such as mitochondria, nuclei, Golgi complexes, lysosomes, endoplasmic reticula, and ribosomes; chemically reactive molecules such as H⁺; superoxides; ATP; citric acid; protein albumin; and combinations thereof. Each biological constituent of a biological system can interact according to some biological mechanism with one or more additional biological constituents of the biological system. A biological mechanism by which biological constituents interact with one another can be known or unknown. A biological mechanism can involve, for example, a biological system's synthetic, regulatory, homeostatic, or control networks. The interaction of one biological constituent with another can include, for example, a synthetic transformation of one biological constituent into another biological constituent, a direct physical interaction of various biological constituents, an indirect interaction of various biological constituents mediated through intermediate biological events, or some other mechanism.

The term “biological process” refers to an interaction or a set of interactions between biological constituents of a biological system. In some instances, a biological process can refer to a set of biological constituents drawn from some aspect of a biological system together with a network of interactions between the biological constituents. Biological processes can include, for example, biochemical or molecular processes. Biological processes can also include, for example, processes that occur within or in contact with an environment of a cell, organ, tissue, or multi-cellular organism. Examples of biological processes include biochemical pathways in which molecules are broken down to provide cellular energy, biochemical pathways in which molecules are built up to provide cellular structure or energy stores, biochemical pathways in which proteins or nucleic acids are synthesized or activated, and biochemical pathways in which protein or nucleic acid precursors are synthesized. Biological constituents of such biochemical pathways can include, for example, enzymes, synthetic intermediates, substrate precursors, and intermediate species. Biological processes can also include, for example, signaling and control pathways. Biological constituents of such pathways can include, for example, primary or intermediate signaling molecules as well as proteins participating in signaling or control cascades that usually characterize such pathways.

Biological processes can be hierarchical, non-hierarchical, or a combination of hierarchical and non-hierarchical. A hierarchical process is one in which biological constituents can be arranged into a hierarchy of levels, such that biological constituents belonging to a particular level can interact with biological constituents belonging to other levels. A hierarchical process generally originates from biological constituents belonging to the lowest levels. A non-hierarchical process is one in which a biological constituent in the process can interact with another biological constituent that is further upstream or downstream. A non-hierarchical process often has one or more feedback loops. A feedback loop in a biological process refers to a subset of biological constituents of the biological process, where each biological constituent of the feedback loop can interact with other biological constituents of the feedback loop.

The term “biomarker” used in connection with a therapy refers to a biological attribute that can be associated with a particular response to the therapy. A biological attribute can include, for example, a rate, a level, an activity, or any other characteristic associated with a set of biological constituents that make up a biological system. In some instances, a biomarker of a therapy can refer to a biological attribute that can be evaluated for a biological system to infer or predict a particular response of the biological system to the therapy. Biomarkers can be predictive of different responses to a therapy. For example, biomarkers can be predictive of effectiveness, biological activity, safety, or side effects of a therapy. In accordance with the methods described herein, a biomarker of one therapy can refer to a biological attribute can be evaluated in response to another therapy. Thus, for example, a response of a patient to either, or both, of a β₂-agonist and a CysLT inhibitor can serve as a biomarker of a PDE4 inhibitor.

The term “therapy” refers to a stimulus or perturbation that can be applied to a biological system. In some instances, a therapy can affect a biological system, such that the biological system can exhibit a response to the therapy. A therapy that increases a rate or stimulates the level or activity of a set of biological constituents can be referred to as an “agonist,” while a therapy that decreases a rate or inhibits the level or activity of a set of biological constituents can be referred to as an “inhibitor.” Therapies that can be applied to a biological system can include, for example, drugs, environmental changes, or combinations thereof.

The term “drug” refers to a compound of any degree of complexity that can affect a biological system, whether by known or unknown biological mechanisms, and whether or not used therapeutically. Examples of drugs include typical small molecules of research or therapeutic interest; naturally-occurring factors such as endocrine, paracrine, or autocrine factors or factors interacting with cell receptors of any type; intracellular factors such as elements of intracellular signaling pathways; factors isolated from other natural sources; pesticides; herbicides; and insecticides. Drugs can also include, for example, agents used in gene therapy such as DNA and RNA. Also, antibodies, viruses, bacteria, and bioactive agents produced by bacteria and viruses (e.g., toxins) can be considered as drugs. A response to a drug can be a consequence of, for example, drug-mediated changes in the rate of transcription or degradation of one or more species of RNA, drug-mediated changes in the rate or extent of translational or post-translational processing of one or more polypeptides, drug-mediated changes in the rate or extent of degradation of one or more proteins, drug-mediated inhibition or stimulation of action or activity of one or more proteins, and so forth. In some instances, drugs can exert their effects by interacting with a protein. For certain applications, drugs can also include, for example, compositions including more than one drug or compositions including one or more drugs and one or more excipients.

The term “phosphodiesterase 4 inhibitor” or “PDE4 inhibitor” refers to a therapy that decreases a rate or inhibits the level or activity of PDE4. As one of ordinary skill in the art will understand, PDE4 typically refers to an enzyme that can be found in inflammatory and immune cells of a biological system and that can operate by catalyzing hydrolysis of cyclic adenosine monophosphates (“cAMPs”) to form inactive monophosphate products. Examples of PDE4 inhibitors include drugs such as Ariflo, Mesopram, Rolipram, Gingko biloba extract EGb 761, Roflumilast, CDP 840, adenine derivatives substituted in position 9, RPR 73401, RP 73401 (“Piclamilast”), 2,2-disubstituted indan-1,3-dione-based PDE4 inhibitors, 6-aryl-4,5 heterocyclic-fused pyridazinones, and derivatives or analogs thereof.

The term “β₂-agonist” refers to a therapy that increases a rate or stimulates the level or activity of β₂-adrenergic receptors. As one of ordinary skill in the art will understand, β₂-adrenergic receptors often can be found in tissues of bronchial smooth muscle and are typically involved in respiratory diseases such as asthma. Examples of β₂-agonists include drugs such as Ablution, Metaproterenol, Terbutaline, Formioterol, Salmeterol, Isoetharine, Pributerol, Bitolterol, Ritodrine, and derivatives or analogs thereof.

The term “cysteinyl leukotriene inhibitor” or “CysLT inhibitor” refers to a therapy that decreases a rate or inhibits the level or activity of CysLT. As one of ordinary skill in the art will understand, CysLT typically refers to a biological constituent that can be found in leukocytes and that can be involved in producing allergic and inflammatory reactions. Examples of CysLT inhibitors include drugs such as Zafirlukast (“Accolate”), Montelukast (“Singulair”), Prankulast, and derivatives or analogs thereof.

The term “measurement” refers to a test configured to evaluate a biological attribute of a biological system. In some instances, a measurement can refer to an experimental or clinical test that can be applied to a biological system to determine a result of the measurement. A measurement can be applied using any of a number of functional, biochemical, and physical techniques appropriate to a particular result being determined. A result of a measurement can include, for example, a rate, a level, an activity, or any other characteristic associated with a set of biological constituents that make up a biological system. For certain applications, a result of a measurement can include a value at one or more times; an absolute or relative increase in a value over a time interval; an absolute or relative decrease in a value over a time interval; an average value; a minimum value; a maximum value; a time at minimum value; a time at maximum value; an area below a curve when values are plotted along a given axis (e.g., time); an area above a curve when values are plotted along a given axis (e.g., time); a pattern or trend associated with a curve when values are plotted along a given axis (e.g., time); a rate of change of a value; an average rate of change of a value; a curvature associated with a value; a number of instances a value exceeds, reaches, or falls below another value (e.g., a predefined value) over a time interval; a minimum difference between a value and another value (e.g., a predefined value) over a time interval; a maximum difference between a value and another value (e.g., a predefined value) over a time interval; a scaled value; a statistical measure associated with a value; or a quantity based on a combination, aggregate representation, or relationship of two or more values.

### Computer System

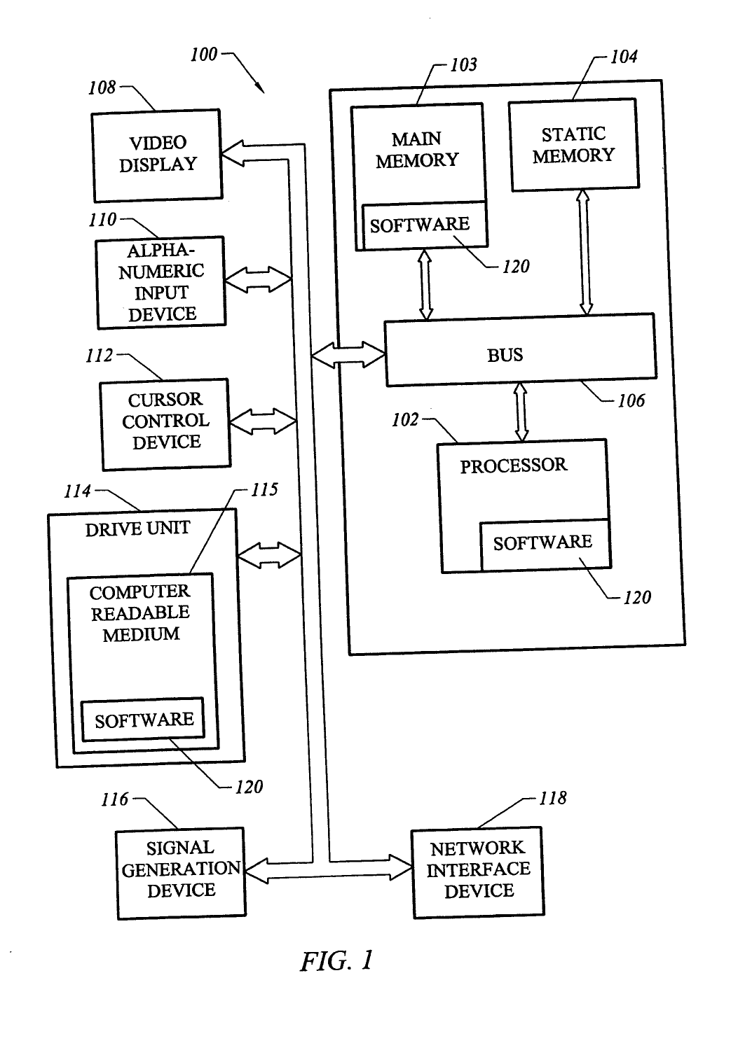

FIG. 1 illustrates a system block diagram of a computer system 100 that can be operated in accordance with some embodiments of the invention. The computer system 100 includes a processor 102, a main memory 103, and a static memory 104, which are coupled by bus 106. The computer system 100 can also include a video display unit 108 (e.g., a liquid crystal display (“LCD”) or a cathode ray tube (“CRT”) display) on which a user-interface can be displayed. The computer system 100 can further include an alpha-numeric input device 110 (e.g., a keyboard), a cursor control device 112 (e.g., a mouse), a disk drive unit 114, a signal generation device 116 (e.g., a speaker), and a network interface device 118. The disk drive unit 114 includes a computer-readable medium 115 storing software code 120 that implements processing according to some embodiments of the invention. The software code 120 can also reside within the main memory 103, the processor 102, or both. For certain applications, the software code 120 can be transmitted or received via the network interface device 118.

### Computer Model of Biological System

The methods according to some embodiments of the invention can be implemented using a computer model that defines a mathematical model of a biological system. Computer models according to some embodiments of the invention can be defined as, for example, described in the following references: Paterson et al., U.S. Pat. No. 6,078,739; Paterson et al., U.S. Pat. No. 6,069,629; Paterson et al., U.S. Pat. No. 6,051,029; Thalhammer-Reyero, U.S. Pat. No. 5,930,154; McAdams et al., U.S. Pat. No. 5,914,891; Fink et al., U.S. Pat. No. 5,808,918; Fink et al., U.S. Pat. No. 5,657,255; Paterson et al., PCT Publication No. WO 99/27443; Paterson et al., PCT Publication No. WO 00/63793; and Winslow et al., PCT Publication No. WO 00/65523; the disclosures of which are incorporated herein by reference in their entirety. Also, computer models according to some embodiments of the invention can be defined as, for example, described in the following co-owned and co-pending patent applications: Kelly et al., entitled “Method and Apparatus for Computer Modeling of an Adaptive Immune Response,” U.S. application Ser. No. 10/186,938, filed on Jun. 28, 2002, and Brazhnik et al., entitled “Method and Apparatus for Computer Modeling Diabetes,” U.S. application Ser. No. 10/040,373, filed on Jan. 9, 2002, the disclosures of which are incorporated herein by reference in their entirety. Suitably, some embodiments of the invention can be implemented using the following commercially available computer models of biological systems: Entelos® Asthma PhysioLab® systems, Entelos® Metabolism PhysioLab® systems, and Entelos® Adipocyte CytoLab® systems.

In some instances, a computer model can define a mathematical model that represents a set of biological processes associated with a biological system using a set of mathematical relations. For example, the computer model can represent a first biological process using a first mathematical relation and a second biological process using a second mathematical relation. In at least one application, the computer model can represent biological processes associated with an immune response to various antigens. A mathematical relation typically includes one or more variables the behavior (e.g., time evolution) of which can be simulated by the computer model. More particularly, mathematical relations of the computer model can define interactions among variables, where the variables can represent biological attributes associated with a set of biological constituents that make up the biological system. In addition, variables can represent various stimuli that can be applied to the biological system.

The behavior of variables can be influenced by a set of parameters included in a computer model. For example, parameters can represent initial values of variables, half-lives of variables, rate constants, conversion ratios, exponents, and curve-fitting parameters. The set of parameters can be included in mathematical relations of the computer model. In some instances, parameters can be used to represent intrinsic characteristics (e.g., genetic factors) as well as external characteristics (e.g., environmental factors) for a biological system.

Mathematical relations used in a computer model can include, for example, ordinary differential equations, partial differential equations, stochastic differential equations, differential algebraic equations, difference equations, cellular automata, coupled maps, equations of networks of Boolean, fuzzy logical networks, or a combination thereof. For certain applications, the mathematical relations are ordinary differential equations that may take the form:
dx/dt=f(x,p,t),
where x is an N dimensional set of variables, t is time, dx/dt is the rate of change of x, p is an M dimensional set of parameters, and f is a function that represents interactions among the variables.

A computer model can be executed to produce a set of outputs for a biological system represented by the computer model. The set of outputs can represent biological attributes associated with a set of biological constituents that make up the biological system. In some instances, the computer model can be configured to simulate the behavior of variables by, for example, numerical or analytical integration of one or more mathematical relations. For example, numerical integration of the ordinary differential equations defined above can be performed to obtain values for the variables x at various times.

In some instances, a computer model allows critical integrated evaluation of conflicting data and alternative hypotheses. The computer model can represent biological processes at a lower hierarchical level and can evaluate the impact of these biological processes on biological processes at a higher hierarchical level. Thus, the computer model can provide a multi-variable view of a biological system. The computer model can also provide cross-disciplinary observations through synthesis of information from two or more disciplines into a single computer model or through linking two computer models that represent different disciplines.

A computer model used to implement some embodiments of the invention can be hierarchical and can reflect a particular biological system and anatomical factors relevant to issues to be explored by the computer model. The level of detail at which a hierarchy starts and the level of detail at which the hierarchy ends are often dictated by a particular intended use of the computer model. Because biological constituents being evaluated often operate at a subcellular level, the lowest level of the hierarchy can be the subcellular level. The subcellular level can include, for example, biological constituents such as DNA, mRNA, proteins, chemically reactive molecules, and subcellular organelles. Because an individual biological system is a common entity of interest with respect to the ultimate effect of the biological constituents, the individual biological system (e.g., represented in the form of clinical observables) can be at the highest level of the hierarchy. The computer model can be configured to allow visual representation of mathematical relations as well as interrelationships between variables, parameters, and biological processes. This visual representation can include multiple modules or functional areas that, when grouped together, represent a large complex model of the biological system.

Computer models used to implement some embodiments of the invention can be validated. Examples of techniques for validation are described in the co-pending and co-owned patent application to Paterson, entitled “Apparatus and Method for Validating a Computer Model,” U.S. application Ser. No. 10/151,581, filed May 16, 2002, the disclosure of which is incorporated herein by reference in its entirety.

For certain applications, a computer model can be used to define one or more configurations. Various configurations of the computer model can be associated with different representations of a biological system represented by the computer model. In particular, various configurations of the computer model can represent, for example, different variations of the biological system having different intrinsic characteristics, different external characteristics, or both. An observable condition (e.g., an outward manifestation) of a biological system can be referred to as its phenotype, while underlying conditions of the biological system that give rise to the phenotype can be based on genetic factors, environmental factors, or both. An example of such an observable condition or phenotype (e.g., a disease phenotype) might be an asthmatic condition or, more specifically, a mild or moderate asthmatic condition that can be exhibited by a human patient. A particular phenotype typically can be reproduced by different underlying conditions (e.g., different combinations of genetic and environmental factors). For example, while two human patients may appear to be similarly asthmatic, one could be asthmatic because of genetic factors, and the other could be asthmatic because of environmental factors. As one of ordinary skill in the art will understand, phenotypes of a biological system can be defined with varying degrees of specificity.

Various configurations of a computer model can be defined to represent different underlying conditions giving rise to a particular phenotype of a biological system. Alternatively, or in conjunction, various configurations of the computer model can be defined to represent different phenotypes of the biological system. In some instances, various configurations of the computer model can be referred to as virtual patients. A virtual patient can be defined to represent a human patient having a phenotype based on a particular combination of underlying conditions. Various virtual patients can be defined to represent human patients having the same phenotype but based on different underlying conditions. Alternatively, or in conjunction, various virtual patients can be defined to represent human patients having different phenotypes.

In some instances, a configuration of a computer model can be associated with a particular set of values for parameters of the computer model. Thus, for example, a first configuration can be associated with a first set of parameter values, and a second configuration can be associated with a second set of parameter values that differs in some fashion from the first set of parameter values. A set of configurations of the computer model can be created based on an initial configuration that is associated with initial parameter values. A different configuration can be created based on the initial configuration by introducing a modification to the initial configuration, such as, for example, a modification to one or more of the initial parameter values. Alternative parameter values can be defined as, for example, described in U.S. Pat. No. 6,078,739 discussed previously. These alternative parameter values can be grouped into different sets of parameter values that can be used to define different configurations of the computer model. Alternatively, or in conjunction, a set of configurations of the computer model can be created based on an initial configuration using linked simulation operations as, for example, described in the co-pending and co-owned patent application to Paterson et al., entitled “Method and Apparatus for Conducting Linked Simulation Operations Utilizing A Computer-Based System Model,” U.S. application Ser. No. 09/814,536, filed Mar. 21, 2001, the disclosure of which is incorporated herein by reference in its entirety.

For certain applications, various configurations of a computer model can represent variations of a biological system that are sufficiently different to evaluate the effect of such variations on a response of the biological system to a therapy. In particular, a set of biological processes represented by the computer model can be identified as playing a role in modulating a response to the therapy, and various configurations can be defined to represent different modifications of the set of biological processes. The identification of the set of biological processes can be based on, for example, experimental or clinical data, scientific literature, results of a computer model, or a combination thereof. Once the set of biological processes at issue have been identified, various configurations can be created by defining different modifications to a set of mathematical relations included in the computer model, which set of mathematical relations represent the set of biological processes.

A biological process that modulates a response to a therapy can be associated with a knowledge gap or uncertainty, and various configurations of a computer model can be defined to represent different plausible hypotheses or resolutions of the knowledge gap. By way of example, biological processes associated with airway smooth muscle (“ASM”) contraction can be identified as playing a role in modulating a response to a therapy for asthma. While it may be understood that inflammatory mediators have an effect on ASM contraction, the relative effects of different types of inflammatory mediators on ASM contraction as well as baseline concentrations of the different types of inflammatory mediators may not be well understood. For such a scenario, various virtual patients can be defined to represent human patients having different baseline concentrations of inflammatory mediators.

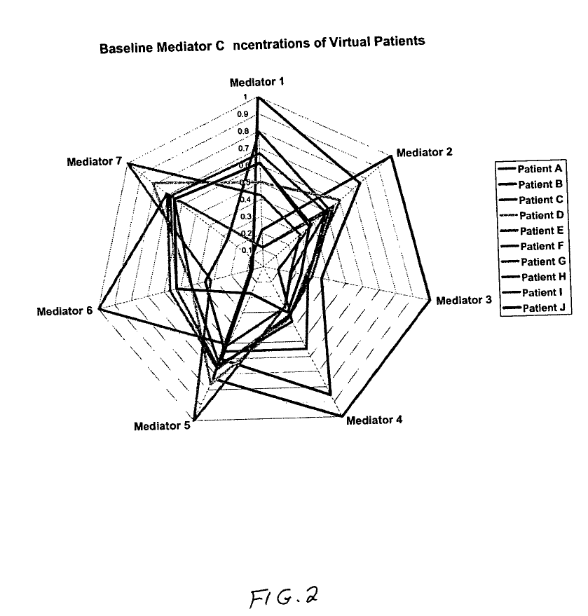

FIG. 2 illustrates a spider chart for various virtual patients that can be defined to represent different human patients, according to an embodiment of the invention. In the illustrated embodiment, 10 virtual patients are defined to represent different moderate asthmatic human patients. For each virtual patient, various parameter values can be specified for a simulation operation to define the virtual patient. In particular, parameters values associated with production levels for various types of inflammatory mediators can be specified to represent a moderate asthmatic human patient having particular baseline concentrations of the various types of inflammatory mediators. As illustrated in FIG. 2, the 10 virtual patients have different baseline concentrations of 7 types of inflammatory mediators.

Once various configurations of a computer model are defined, the behavior of the various configurations can be used for predictive analysis. In particular, a set of configurations can be used to predict the behavior of different representations of a biological system when subjected to various stimuli. A virtual stimulus can be defined to simulate a stimulus or perturbation that can be applied to the biological system. The computer model can be executed based on the virtual stimulus to obtain a set of outputs for the biological system represented by the computer model. In some instances, a virtual stimulus can be defined to simulate a therapy that can be administered to the biological system and can be referred to as a virtual therapy. For example, the computer model can include parameters that when altered simulate the administration of a therapy for asthma.

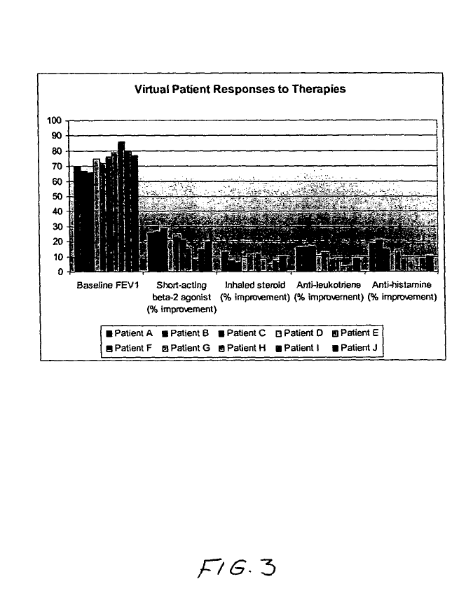

FIG. 3 illustrates a bar chart for various virtual patients that can be defined to represent different human patients, according to an embodiment of the invention. In the illustrated embodiment, 10 virtual patients are defined to represent different moderate asthmatic human patients. Various virtual therapies are defined to evaluate the behavior of the virtual patients based on the virtual therapies, and outputs of the virtual therapies are illustrated for each virtual patient. In particular, 4 virtual therapies are defined to simulate a short-acting β₂-agonist, an inhaled steroid, an anti-leukotriene (e.g., a CysLT inhibitor), and an anti-histamine. In the illustrated embodiment, outputs of the virtual therapies are expressed as a percentage change of a baseline value of forced expiratory volume in one second (“FEV1”) at a subsequent time relative to a baseline value of FEV1 at an initial time. As one of ordinary skill in the art will understand, FEV1 can be indicative of effectiveness of a therapy for asthma. The outputs of the virtual therapies can be produced based on a variable in a computer model that represents FEV1 at various times. As illustrated in FIG. 3, the outputs of the virtual therapies differ across the virtual patients.

### Using Computer Model to Identify Biomarkers

Once a computer model is defined to represent a biological system, it can be used for the purpose of identifying one or more biomarkers of a therapy for the biological system. Execution of the computer model can produce various sets of outputs, and correlation analysis can be performed on the sets of outputs to identify one or more biomarkers of the therapy. Examples of techniques for identifying biomarkers using correlation analysis are described in the co-pending and co-owned patent application to Paterson et al., entitled “Apparatus and Method for Identifying Biomarkers Using a Computer Model,” U.S. application Ser. No. 10/319,779, filed Dec. 12, 2002, the disclosure of which is incorporated herein by reference in its entirety.

For example, a virtual therapy can be defined to simulate the therapy, and various sets of outputs can be produced by executing the computer model absent the virtual therapy and based on the virtual therapy. Correlation analysis can be performed on the sets of outputs to identify a set of outputs produced absent the virtual therapy that is correlated with a set of outputs produced based on the virtual therapy. The set of outputs produced based on the virtual therapy can represent a particular response to the therapy, such as, for example, effectiveness of the therapy. In some instances, the sets of outputs can be associated with different points in time, and correlation analysis can be performed on the sets of outputs to identify a set of outputs produced at an earlier point in time that is correlated with a set of outputs produced at a subsequent point in time.

For certain applications, multiple configurations of the computer model can be defined, and the computer model can be executed to produce outputs for each configuration of the multiple configurations. Also, various virtual therapies can be defined to simulate different therapies, and various sets of outputs can be produced by executing the computer model based on the virtual therapies. Correlation analysis can be performed on the sets of outputs to identify a set of outputs produced based on one virtual therapy that is correlated with a set of outputs produced based on another virtual therapy.

In some instances, two or more sets of outputs can be determined to be correlated based on one or more standard statistical tests. Statistical tests that can be used to identify correlation can include, for example, linear regression analysis, nonlinear regression analysis, and rank correlation test. In accordance with a particular statistical test, a correlation coefficient can be determined, and correlation can be identified based on determining that the correlation coefficient falls within a particular range or falls above or below a threshold value. Examples of correlation coefficients include goodness of fit statistical quantity r² associated with linear regression analysis and Spearman Rank Correlation coefficient rₛ associated with rank correlation test.

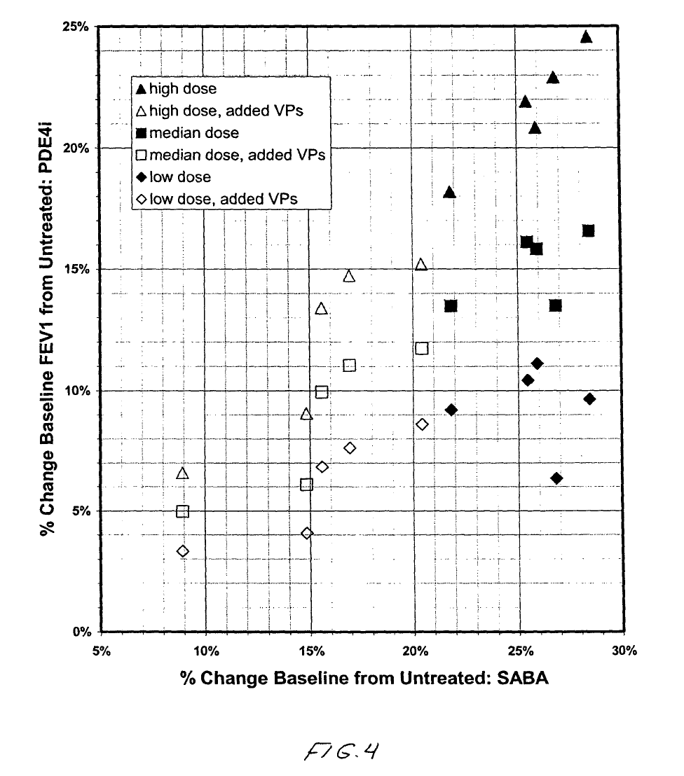

FIG. 4 illustrates a scatter-gram that plots outputs of two virtual therapies for various virtual patients, according to an embodiment of the invention. In the illustrated embodiment, 10 virtual patients are defined to represent different moderate asthmatic human patients. A first and second virtual therapies are defined to evaluate the behavior of the virtual patients based on the virtual therapies, and outputs of the virtual therapies are illustrated for each virtual patient. In particular, the first virtual therapy is defined to simulate a short-acting β₂-agonist (labeled as “SABA”), while the second virtual therapy is defined to simulate a PDE4 inhibitor (labeled as “PDE4i”). Three different doses of the PDE4 inhibitor are simulated, and outputs for the virtual patients at each dose of the PDE4 inhibitor are illustrated. In the illustrated embodiment, outputs of the virtual therapies are expressed as a percentage change of a baseline value of FEV1 at a subsequent time relative to a baseline value of FEV1 at an initial time. As illustrated in FIG. 4, outputs of the first virtual therapy can be determined to be correlated with outputs of the second virtual therapy. Accordingly, a percentage change of a baseline value of FEV1 in response to the short-acting β₂-agonist can be identified as a biomarker that is predictive of a percentage change of a baseline value of FEV1 in response to the PDE4 inhibitor. In particular, a percentage change of a baseline value of FEV1 in response to the short-acting β₂-agonist can be evaluated for a moderate asthmatic human patient to predict the degree of effectiveness of the PDE4 inhibitor for that moderate asthmatic human patient. As illustrated in FIG. 4, the scatter-gram indicates that a greater degree of effectiveness of the PDE4 inhibitor can be predicted for a moderate asthmatic human patient if a greater degree of effectiveness of the short-acting β₂-agonist is observed for that moderate asthmatic human patient.

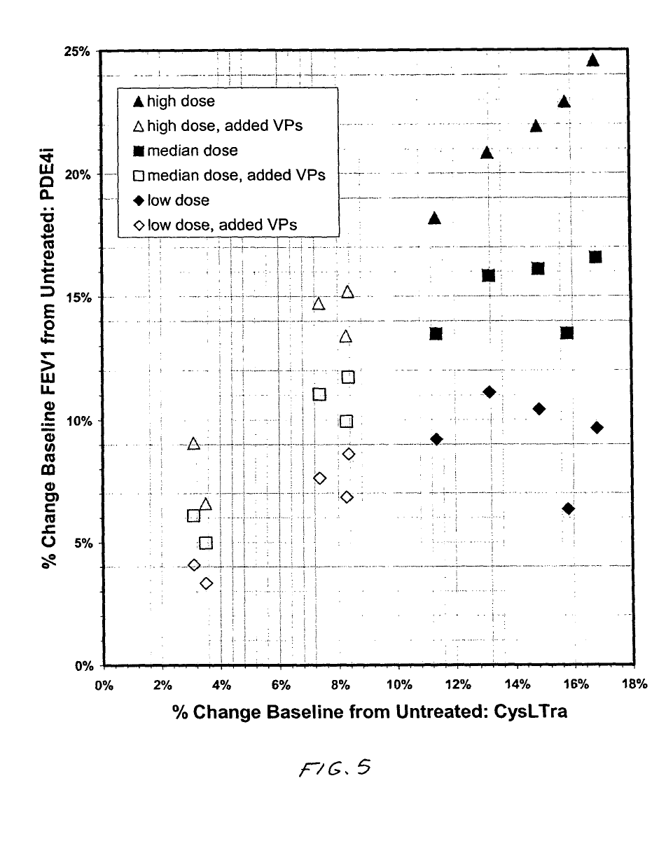

FIG. 5 illustrates another scatter-gram that plots outputs of two virtual therapies for various virtual patients, according to an embodiment of the invention. As discussed previously for FIG. 4, 10 virtual patients are defined to represent different moderate asthmatic human patients. Here, a first virtual therapy is defined to simulate a CysLT inhibitor (labeled as “CysLTra”), while a second virtual therapy is defined to simulate a PDE4 inhibitor (labeled as “PDE4i”). Three different doses of the PDE4 inhibitor are simulated, and outputs for the virtual patients at each dose of the PDE4 inhibitor are illustrated. In the illustrated embodiment, outputs of the virtual therapies are expressed as a percentage change of a baseline value of FEV1 at a subsequent time relative to a baseline value of FEV1 at an initial time. Again, outputs of the first virtual therapy can be determined to be correlated with outputs of the second virtual therapy. Accordingly, a percentage change of a baseline value of FEV1 in response to the CysLT inhibitor can be identified as a biomarker that is predictive of a percentage change of a baseline value of FEV1 in response to the PDE4 inhibitor. In particular, a percentage change of a baseline value of FEV1 in response to the CysLT inhibitor can be evaluated for a moderate asthmatic human patient to predict the degree of effectiveness of the PDE4 inhibitor for that moderate asthmatic human patient. As illustrated in FIG. 5, the scatter-gram indicates that a greater degree of effectiveness of the PDE4 inhibitor can be predicted for a moderate asthmatic human patient if a greater degree of effectiveness of the CysLT inhibitor is observed for that moderate asthmatic human patient.

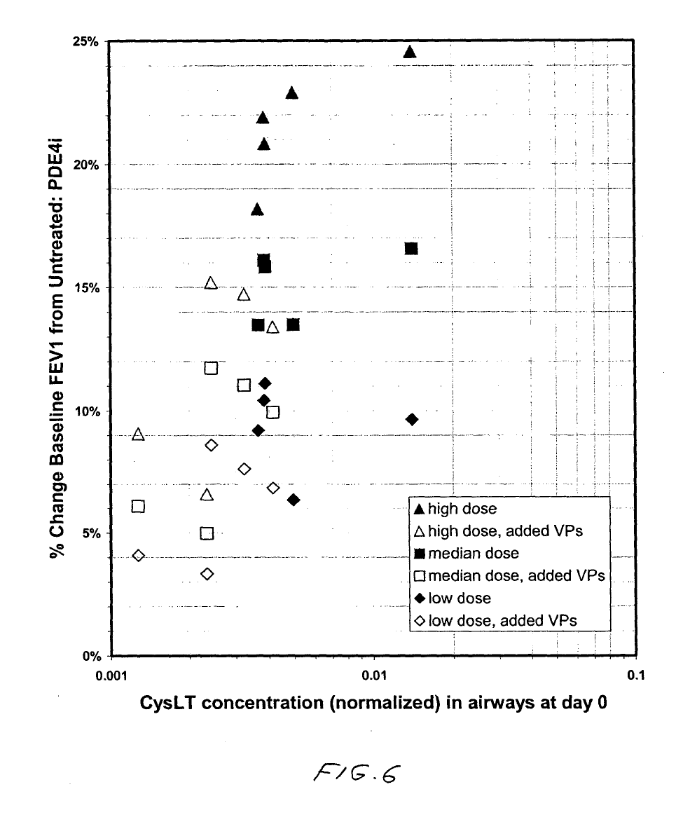

FIG. 6 illustrates a further scatter-gram that plots outputs for various virtual patients, according to an embodiment of the invention. As discussed previously for FIG. 4 and FIG. 5, 10 virtual patients are defined to represent different moderate asthmatic human patients. Here, outputs associated with airway concentrations of CysLT at an initial time are plotted versus outputs of a virtual therapy defined to simulate a PDE4 inhibitor (labeled as “PDE4i”). Three different doses of the PDE4 inhibitor are simulated, and outputs for the virtual patients at each dose of the PDE4 inhibitor are illustrated. In the illustrated embodiment, outputs of the virtual therapy are expressed as a percentage change of a baseline value of FEV1 at a subsequent time relative to a baseline value of FEV1 at an initial time. As illustrated in FIG. 6, no significant correlation between the outputs can be determined. Accordingly, the scatter-gram indicates that an initial airway concentration of CysLT may not be predictive of a percentage change of a baseline value of FEV1 in response to the PDE4 inhibitor.

### Using Identified Biomarkers

Once a biomarker of a therapy has been identified, it can be used for various applications. For some embodiments of the invention, a biomarker of a PDE4 inhibitor can be used to develop the PDE4 inhibitor to treat various diseases, such as, for example, mild or moderate asthma. For example, a biomarker of the PDE4 inhibitor can be evaluated for a human patient to predict the degree of effectiveness of the PDE4 inhibitor for that human patient prior to a clinical trial. Such a biomarker can be used as an inclusion or exclusion criteria to select a group of human patients for the clinical trial, such that the clinical trial can target human patients that are likely to respond well to the PDE4 inhibitor. In particular, the group of human patients can be selected based on whether a measurement of the biomarker indicates a sufficient degree of effectiveness of the PDE4 inhibitor for that group of human patients. As another example, a biomarker of the PDE4 inhibitor can be evaluated for a group of human patients as a variance reducing measure in the design of the clinical trial. Such a biomarker can be evaluated as a continuous variable and can be used as a covariate in an analysis of covariance for the clinical trial. As yet another example, a biomarker of the PDE4 inhibitor can be evaluated for a human patient during the course of the clinical trial to predict a surrogate end-point or outcome of the PDE4 inhibitor for that human patient. Such a biomarker can be used to evaluate effectiveness of the PDE4 inhibitor during the course of the clinical trial to determine, for example, whether to abort or alter the clinical trial. As a further example, a biomarker of the PDE4 inhibitor can be evaluated for a human patient during the course of the clinical trial to assess biological activity of the PDE4 inhibitor for that human patient.

Subsequent to developing a PDE4 inhibitor, a biomarker of the PDE4 inhibitor can be used to implement the PDE4 inhibitor to treat various diseases. For example, a biomarker of the PDE4 inhibitor can be evaluated for a human patient to predict the degree of effectiveness of the PDE4 inhibitor for that human patient. Such a biomarker can be used by physicians to select human patients that are likely to respond well to the therapy. As another example, a biomarker of the PDE4 inhibitor can be evaluated for a human patient during the course of treatment to predict a surrogate end-point or to assess biological activity of the PDE4 inhibitor for that human patient. Such a biomarker can be used to determine, for example, how well that human patient is responding to the PDE4 inhibitor.

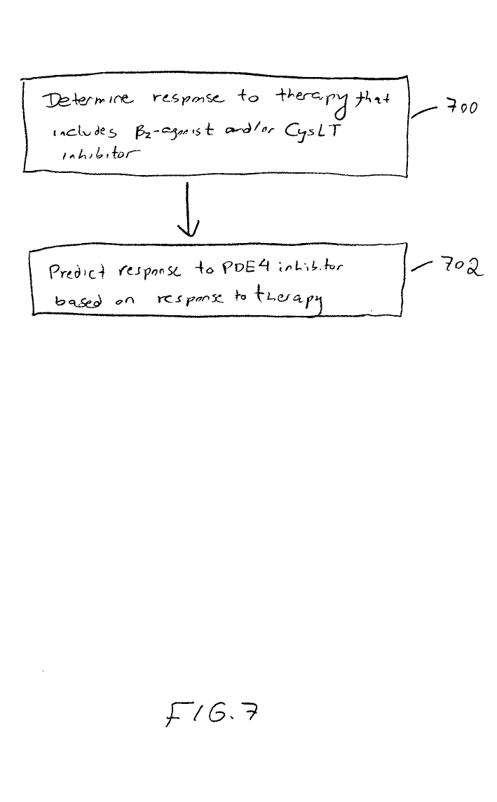

FIG. 7 illustrates a flow chart for predicting a response of a patient to a PDE4 inhibitor, according to an embodiment of the invention. At step 700, a response of the patient to a therapy is determined. In the illustrated embodiment, the therapy can include at least one of a β₂-agonist and a CysLT inhibitor, and the therapy can be administered to the patient using any of a number of techniques, such as, for example, orally, via inhalation, intravenously, and so forth. In some instances, the therapy can include both of the β₂-agonist and the CysLT inhibitor, and the β₂-agonist and the CysLT inhibitor can be administered to the patient at the same time or at different times. Typically, a therapeutically effective dose of the therapy is administered to the patient, which therapeutically effective dose can be determined using standard techniques.

Once the therapy is administered to the patient, a measurement can be applied to the patient to determine a treated result of the measurement. The measurement can be applied using any of a number of functional, biochemical, and physical techniques appropriate to the treated result being determined. Typically, the treated result of the measurement is associated with the response of the patient to the therapy. In some instances, the measurement can be configured to evaluate effectiveness of the therapy for the patient. Thus, for example, the measurement can be configured to evaluate FEV1 for the patient, and the treated result of the measurement can correspond to a value of FEV1 (e.g., a baseline value of FEV1) for the patient in response to the therapy.

For certain applications, the treated result of the measurement can be compared with an initial or untreated result of the measurement to determine the response of the patient to the therapy. Typically, the untreated result of the measurement is associated with a condition of the patient absent the therapy. In some instances, the measurement can be applied to the patient prior to administering the therapy to determine the untreated result of the measurement. Thus, for example, the measurement can be configured to evaluate FEV1 for the patient, and the untreated result of the measurement can correspond to a value of FEV1 for the patient prior to administering the therapy. In some instances, the response to the therapy can be determined based on determining a difference (if any) between the treated result of the measurement and the untreated result of the measurement. In particular, the response to the therapy can be determined as a relative change (e.g., a percentage change) of the treated result of the measurement relative to the untreated result of the measurement. Thus, for example, the response to the therapy can be determined as a percentage change of a value of FEV1 for the patient in response to the therapy relative to a value of FEV1 for the patient prior to administering the therapy.

At step 702, the response of the patient to the PDE4 inhibitor is predicted based on the response of the patient to the therapy. In the illustrated embodiment, the response of the patient to the PDE4 inhibitor can be predicted based on an identified correlation between the response of the patient to the PDE4 inhibitor and the response of the patient to the therapy. As discussed previously in connection with FIG. 4 and FIG. 5, a greater degree of effectiveness of the PDE4 inhibitor can be predicted for the patient if a greater degree of effectiveness of the β₂-agonist or the CysLT inhibitor is observed for the patient. Thus, in the illustrated embodiment of FIG. 7, if the therapy is determined to be effective for the patient, the PDE4 inhibitor can be determined as being potentially effective for the patient. On the other hand, if the therapy is determined to be not effective for the patient, the PDE4 inhibitor can be determined as not being potentially effective for the patient. Effectiveness of the therapy for the patient can be determined based on whether the response of the patient to the therapy falls within a certain range or falls above or below a threshold value. Thus, for example, the therapy can be determined to be effective for the patient if a percentage change of a value of FEV1 for the patient falls above a threshold value (e.g., 0 percent or 4 percent).

### EXAMPLE

The following example is provided as a guide for a practitioner of ordinary skill in the art. The example should not be construed as limiting the invention, as the example merely provides specific methodology useful in understanding and practicing an embodiment of the invention.

10 virtual patients were defined to represent different moderate asthmatic human patients. For each virtual patient, various parameter values were specified for a simulation operation to define the virtual patient. In particular, parameters values associated with production levels for 7 types of inflammatory mediators were specified to represent a moderate asthmatic human patient having particular baseline concentrations of the 7 types of inflammatory mediators. The 7 types of inflammatory mediators included basophil inflammatory mediators, sensory nerve inflammatory mediators, eosinophil CysLT mediators, epithelial inflammatory mediators, bradykinin mediators, macrophage inflammatory mediators, and mast cell inflammatory mediators.

A virtual therapy was defined to simulate a generic PDE4 inhibitor that represented a group of candidate PDE4 inhibitors. In particular, the virtual therapy was defined by first estimating pharmacodynamic responses to each candidate PDE4 inhibitor for a number of target biological constituents. The estimated pharmacodynamic responses were determined based on experimental data, including human data in vitro, animal or cellular data from a cell in a relevant biological process, and cellular data from human patients. The experimental data was extrapolated using ratios of observed pharmacodynamic responses to the candidate PDE4 inhibitors relative to pharmacodynamic responses to 2 commercially available PDE4 inhibitors, namely Ariflo and Rolipram. By sampling the group of candidate PDE4 inhibitors and averaging their estimated pharmacodynamic responses, estimated pharmacodynamic responses to the generic PDE4 inhibitor were derived. Inhibition of each target biological constituent was assumed to be complete and continuous for the entire period of an experiment. The estimated pharmacodynamic responses to the generic PDE4 inhibitor included estimated values for a 50 percent inhibition concentration (“IC50”) for eosinophil CysLT (estimated IC50 value=74 nanoMolar), eosinophil reactive oxygen (estimated IC50 value=750 nanoMolar), eosinophil derived neurotoxin (estimated IC50 value=450 nanoMolar), eosinophil chemotaxis (estimated IC50 value=1.3 microMolar), eosinophil survival (estimated IC50 value=3.8 microMolar), basophil histamine (estimated IC50 value=3.8 microMolar), T-cell interleukin-5 (“IL-5”) (estimated IC50 value=1.3 microMolar), T-cell proliferation (estimated IC50 value=2.9 microMolar), and neutrophil recruitment (estimated IC50 value=4 nanoMolar).

Using the 10 virtual patients, a computer model was executed to produce various sets of outputs, and correlation analysis was performed on the sets of outputs to identify biomarkers of the generic PDE4 inhibitor. Three different doses of the generic PDE4 inhibitor were simulated, and outputs for the 10 virtual patients at each dose of the PDE4 inhibitor were produced. In connection with identifying the biomarkers, additional virtual therapies were defined to simulate various standard therapies, including a short-acting β₂-agonist, a long-acting β₂-agonist, a CysLT inhibitor, an anti-histamine, a steroid, and an anti-cholinergic.

No significant correlation was observed between a response to the generic PDE4 inhibitor and the level of a biological constituent (e.g., a cell number or a concentration of an inflammatory mediator). However, responses to the short-acting β₂-agonist and the long-acting β₂-agonist were observed to be substantially correlated with the response to the generic PDE4 inhibitor. For the short-acting γ₂-agonist, correlation was observed to improve with increasing dose of the generic PDE4 inhibitor, and a goodness of fit statistical quantity r² was determined to range from about 0.55 to about 0.97 with increasing dose of the generic PDE4 inhibitor. Similarly, a response to the CysLT inhibitor was observed to be substantially correlated with the response to the genetic PDE4 inhibitor. In particular, for the CysLT inhibitor, correlation was also observed to improve with increasing dose of the generic PDE4 inhibitor, and a goodness of fit statistical quantity r² was determined to range from about 0.62 to about 0.96 with increasing dose of the generic PDE4 inhibitor. Thus, the present example demonstrates that a response to a standard and readily available therapy can serve as a useful biomarker of a PDE4 inhibitor, since the response to the therapy can be easily, inexpensively, and non-invasively measured in a clinical setting.

It should be recognized that the specific methods discussed above are provided by way of example, and various other embodiments are contemplated. For example, while certain embodiments have been described herein with reference to use of a β₂-agonist and a CysLT inhibitor, it should be understood by one of ordinary skill in the art that embodiments of the invention are not limited to use of such therapies and, specifically, are not limited to the ability to predict effectiveness of a PDE4 inhibitor using such therapies.

An embodiment of the invention relates to a computer storage product including a computer-readable medium having computer-executable code thereon for performing various computer-implemented operations. The term “computer-readable medium” is used herein to include any medium that is capable of storing or encoding a sequence of instructions or codes for performing the methods described herein. The media and code may be those specially designed and constructed for the purposes of the invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; carrier waves signals; and hardware devices that are specially configured to store and execute program code, such as application-specific integrated circuits (“ASICs”), programmable logic devices (“PLDs”), read only memories (“ROMs”), random access memories (“RAMs”), erasable programmable read only memories (“EPROMs”), and electrically erasable programmable read only memories (“EEPROMs”). Examples of computer-executable code include machine code, such as produced by a compiler, and files containing higher-level code that are executed by a computer using an interpreter. For example, an embodiment of the invention may be implemented using Java, C++, or other object-oriented programming language and development tools. Additional examples of computer-executable code include encrypted code and compressed code.

Moreover, an embodiment of the invention may be downloaded as a computer program product, where the program may be transferred from a remote computer (e.g., a server) to a requesting computer (e.g., a client) by way of data signals embodied in a carrier wave or other propagation medium via a communication link (e.g., a modem or network connection). Accordingly, as used herein, a carrier wave can be regarded as a computer-readable medium.

Another embodiment of the invention may be implemented in hardwired circuitry in place of, or in combination with, computer-executable code.

Each of the patent applications, patents, publications, and other published documents mentioned or referred to in this specification is herein incorporated by reference in its entirety, to the same extent as if each individual patent application, patent, publication, and other published document was specifically and individually indicated to be incorporated by reference.

While the invention has been described with reference to the specific embodiments thereof, it should be understood by those skilled in the art that various changes may be made and equivalents may be substituted without departing from the true spirit and scope of the invention as defined by the claims. In addition, many modifications may be made to adapt a particular situation, material, composition of matter, method, process operation or operations, to the spirit and scope of the invention. All such modifications are intended to be within the scope of the claims. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

1. A method of predicting effectiveness of a PDE4 inhibitor, comprising:
administering a β₂-agonist to a patient having asthma;
applying a measurement to the patient to determine a treated result of the measurement, the measurement being configured to evaluate effectiveness of the β₂-agonist for the patient; and
predicting effectiveness of the PDE4 inhibitor for the patient based on the treated result of the measurement.

2. The method of claim 1, further comprising:
comparing the treated result of the measurement with an untreated result of the measurement.

3. The method of claim 2, further comprising:
prior to administering the β₂-agonist to the patient, applying the measurement to the patient to determine the untreated result of the measurement.

4. The method of claim 2, wherein comparing the treated result of the measurement with the untreated result of the measurement includes:
determining a difference between the treated result of the measurement and the untreated result of the measurement.

5. The method of claim 4, wherein predicting the effectiveness of the PDE4 inhibitor for the patient includes:
predicting the effectiveness of the PDE4 inhibitor for the patient based on the difference between the treated result of the measurement and the untreated result of the measurement.

6. The method of claim 1, wherein the measurement is configured to evaluate a forced expiratory volume in one second for the patient.

7. A method of predicting effectiveness of a PDE4 inhibitor, comprising:
administering a CysLT inhibitor to a patient having asthma;
applying a measurement to the patient to determine a treated result of the measurement, the measurement being configured to evaluate effectiveness of the CysLT inhibitor for the patient; and
predicting effectiveness of the PDE4 inhibitor for the patient based on the treated result of the measurement.

8. The method of claim 7, further comprising:
comparing the treated result of the measurement with an untreated result of the measurement.

9. The method of claim 8, further comprising:
prior to administering the CysLT inhibitor to the patient, applying the measurement to the patient to determine the untreated result of the measurement.

10. The method of claim 8, wherein comparing the treated result of the measurement with the untreated result of the measurement includes:
determining a difference between the treated result of the measurement and the untreated result of the measurement.

11. The method of claim 10, wherein predicting the effectiveness of the PDE4 inhibitor for the patient includes:
predicting the effectiveness of the PDE4 inhibitor for the patient based on the difference between the treated result of the measurement and the untreated result of the measurement.

12. The method of claim 7, wherein the measurement is configured to evaluate a forced expiratory volume in one second for the patient.

13. A method of predicting effectiveness of a PDE4 inhibitor, comprising:
administering a therapy to a human patient having asthma, the therapy including at least one of a β₂-agonist and a CysLT inhibitor;
determining effectiveness of the therapy for the human patient; and
predicting effectiveness of the PDE4 inhibitor for the human patient based on the effectiveness of the therapy for the human patient.

14. The method of claim 13, wherein determining the effectiveness of the therapy for the human patient includes:
applying a measurement to the human patient to determine a treated result of the measurement; and
determining a difference between the treated result of the measurement and an untreated result of the measurement.

15. The method of claim 14, wherein the measurement is configured to evaluate a forced expiratory volume in one second for the human patient.

16. The method of claim 13, wherein the therapy includes the β₂-agonist and the CysLT inhibitor.

17. A method of predicting effectiveness of a PDE4 inhibitor, comprising:
determining a response of a human patient to a therapy, the therapy including at least one of a β₂-agonist and a CysLT inhibitor; and
predicting effectiveness of the PDE4 inhibitor for the human patient based on the response of the human patient to the therapy.

18. The method of claim 17, wherein determining the response of the human patient to the therapy includes:
administering the therapy to the human patient;
applying a measurement to the human patient to determine a treated result of the measurement; and
comparing the treated result of the measurement with an untreated result of the measurement to determine the response of the human patient to the therapy.

19. The method of claim 18, wherein determining the response of the human patient to the therapy further includes:
prior to administering the therapy to the human patient, applying the measurement to the human patient to determine the untreated result of the measurement.

20. The method of claim 18, wherein the measurement is configured to evaluate a forced expiratory volume in one second for the human patient.

21. The method of claim 17, wherein the therapy includes the β₂-agonist and the CysLT inhibitor.

22. A method of performing a clinical trial of a PDE4 inhibitor, comprising:
administering a therapy to a human patient, the therapy including at least one of a β₂-agonist and a CysLT inhibitor;
applying a measurement to the human patient to determine a response of the human patient to the therapy; and
selecting the human patient for the clinical trial of the PDE4 inhibitor based on the response of the human patient to the therapy.

23. The method of claim 22, wherein the measurement is configured to evaluate a forced expiratory volume in one second for the human patient.

24. The method of claim 22, wherein the therapy includes the β₂-agonist and the CysLT inhibitor.

25. The method of claim 22, wherein selecting the human patient for the clinical trial of the PDE4 inhibitor includes:
predicting effectiveness of the PDE4 inhibitor for the human patient based on the response of the human patient to the therapy.

26. The method of claim 25, further comprising:
receiving an identification of the response of the human patient to the therapy as a biomarker of the PDE4 inhibitor, the identification being based on a computer-based simulation of a plurality of virtual patients, each virtual patient of the plurality of virtual patients being associated with a different human patient.
